(19) United States
(12) Patent Application Publication
(10) Pub. No.: US 2017/0270826 A1
(43) Pub. Date: Sep. 21, 2017

(54) TEXTURED AND VISUAL TEACHING AID

(71) Applicant: Maria Stella Guadagnoli, Mississauga (CA)

(72) Inventor: Maria Stella Guadagnoli, Mississauga (CA)

(21) Appl. No.: 15/072,326

(22) Filed: Mar. 16, 2016

(51) Int. Cl. G09B 21/00; G09B 19/04

(52) U.S. Cl. CPC G09B 21/007; G09B 19/04

(57) ABSTRACT

A teaching aid for teaching written and oral composition, comprising: a) an introduction paragraph, one or more body paragraphs and a conclusion paragraph, wherein sentences of the paragraphs are arranged in a selected order; b) an introduction paragraph and conclusion paragraph board portion comprising a plurality of discrete rows of visually and texturally different articles arranged in a selected order and in an hourglass shape; and c) at least one body paragraph board portion comprising a plurality of discrete rows of visually and texturally different articles arranged in a selected order and in an hourglass, square or rectangular shape, wherein the sentences of the paragraphs are provided via an instructor reading, audio source, printed text source and/or Braille source.

### FIELD OF THE INVENTION

The present disclosure is in the field of written and oral composition teaching aids.

### BACKGROUND OF THE DISCLOSURE

The challenges encountered with instructing students to write coherent paragraphs and a subsequent essay is prevalent among young and inexperienced writers. Traditionally, academic writing is taught via oral presentations, followed by an instructor's analysis and evaluation. Students generally lack an understanding of writing composition structure, because they are unsure of the specifics pertaining to a composition's structure. Further challenges exist with instructing visually impaired students to recognize and extrapolate writing composition structure given the nature of their impairments.

Writing composition instruction could benefit from a system that utilizes both the senses of sight and touch as part of a system or process to mastering effective written and oral composition skills.

### SUMMARY OF THE INVENTION

A teaching aid for teaching written and oral composition, comprising: a) an introduction paragraph, a conclusion paragraph, wherein sentences of the paragraphs are arranged in a selected order; b) an introduction paragraph and conclusion paragraph board portion comprising a plurality of discrete rows of visually and texturally different articles arranged in a selected order and in an hourglass shape, wherein the order of the rows of a top half of the hourglass corresponds with the selected order of the one or more sentences of the introduction of the written or oral composition, and wherein the order of the rows of a bottom half of the hourglass corresponds to the selected order of the one or more sentences of the conclusion of the written or oral composition; and c) at least one body paragraph board portion comprising a plurality of discrete rows of visually and texturally different articles arranged in a selected order and in an hourglass, square or rectangular shape, wherein the order of the rows corresponds with the selected order of the one or more sentences of body paragraph of the written or oral composition, wherein the sentences of the paragraphs are provided via an instructor reading, audio source, printed text source and/or Braille source.

A method of using a teaching aid for teaching written and oral composition comprising the steps of: a) providing one or more introduction paragraphs, one or more body paragraphs and one or more conclusion paragraphs, wherein sentences of the paragraphs are arranged in a selected order; b) providing an introduction paragraph and conclusion paragraph board portion comprising a plurality of discrete rows of visually and texturally different articles arranged in a selected order and in an hourglass shape, wherein the order of the rows of a top half of the hourglass corresponds with the selected order of the one or more sentences of the introduction of the written or oral composition, and wherein the order of the rows of a bottom half of the hourglass corresponds to the selected order of the one or more sentences of the conclusion of the written or oral composition; c) correlating each row of the introduction paragraph and conclusion paragraph board via visual and/or tactile information provided by each distinct row with a corresponding sentence the one or more introduction paragraphs and the one or more conclusion paragraphs of the written or oral composition; d) providing at least one body paragraph board portion comprising a plurality of discrete rows of visually and texturally different articles arranged in a selected order and in an hourglass, square or rectangular shape, wherein the order of the rows corresponds with the selected order of the one or more sentences of body paragraph of the written or oral composition; and e) correlating each row of the body paragraph board via visual and/or tactile information provided by each distinct row with a corresponding sentence of the at least one body paragraph of the written or oral composition, wherein the sentences of the paragraphs are provided via an instructor reading, audio source, printed text source and/or Braille source.

A kit for guiding a user through a writing process using a teaching aid for teaching written and oral composition, the kit comprising a) an introduction paragraph and conclusion paragraph board portion comprising a plurality of discrete rows of visually and texturally different articles arranged in a selected order and in an hourglass shape, wherein the order of the rows of a top half of the hourglass corresponds with the selected order of the one or more sentences of the introduction of the written or oral composition, and wherein the order of the rows of a bottom half of the hourglass corresponds to the selected order of the one or more sentences of the conclusion of the written or oral composition; b) at least one body paragraph board portion comprising a plurality of discrete rows of visually and texturally different articles arranged in a selected order and in an hourglass, square or rectangular shape, wherein the order of the rows corresponds with the selected order of the one or more sentences of body paragraph of the written or oral composition; and c) one or more introduction paragraphs, one or more body paragraphs and one or more conclusion paragraphs, wherein sentences of the paragraphs are arranged in a selected order, and wherein the sentences of the paragraphs are provided via an instructor reading, audio source, printed text source and/or Braille source.

### BRIEF DESCRIPTION OF THE DRAWINGS

FIG. 1 is an illustration of an introduction paragraph and conclusion paragraph board portion 100, comprising a plurality of discrete rows 102, 104, 106, 108, 110, 112, 114, 116, 118, 120, 122, 124 and 126 of visually and texturally different articles arranged in a selected order and in an hourglass shape.

FIG. 2 is a depiction of a body paragraph board portion 200 comprising a plurality of discrete rows 202, 204, 206, 208, 210, 212, 214, 216, 218 and 220 of visually and texturally different articles arranged in a selected order and in an hourglass, square or rectangular shape.

FIG. 3 is a depiction of a body paragraph board portion 300 comprising a plurality of discrete rows 302, 304, 306, 308, 310, 312, 314, 316, 318 and 320 of visually and texturally different articles arranged in a selected order and in an hourglass, square or rectangular shape.

### DETAILED DESCRIPTION OF THE EMBODIMENTS

The following is a detailed description of certain specific embodiments of the teaching aid and methods disclosed herein.

In one aspect, disclosed herein is a teaching aid for teaching written and oral composition, comprising: a) one or more introduction paragraphs, one or more body paragraphs and one or more conclusion paragraphs, wherein sentences of the paragraphs are arranged in a selected order; b) an introduction paragraph and conclusion paragraph board portion comprising a plurality of discrete rows of visually and texturally different articles arranged in a selected order and in an hourglass shape, wherein the order of the rows of a top half of the hourglass corresponds with the selected order of the one or more sentences of the introduction of the written or oral composition, and wherein the order of the rows of a bottom half of the hourglass corresponds to the selected order of the one or more sentences of the conclusion of the written or oral composition; and c) at least one body paragraph board portion comprising a plurality of discrete rows of visually and texturally different articles arranged in a selected order and in an hourglass, square or rectangular shape, wherein the order of the rows corresponds with the selected order of the one or more sentences of body paragraph of the written or oral composition, wherein the sentences of the paragraphs are provided via an instructor reading, audio source, printed text source and/or Braille source, and wherein the teaching aid provides kinesthetic learning to the user.

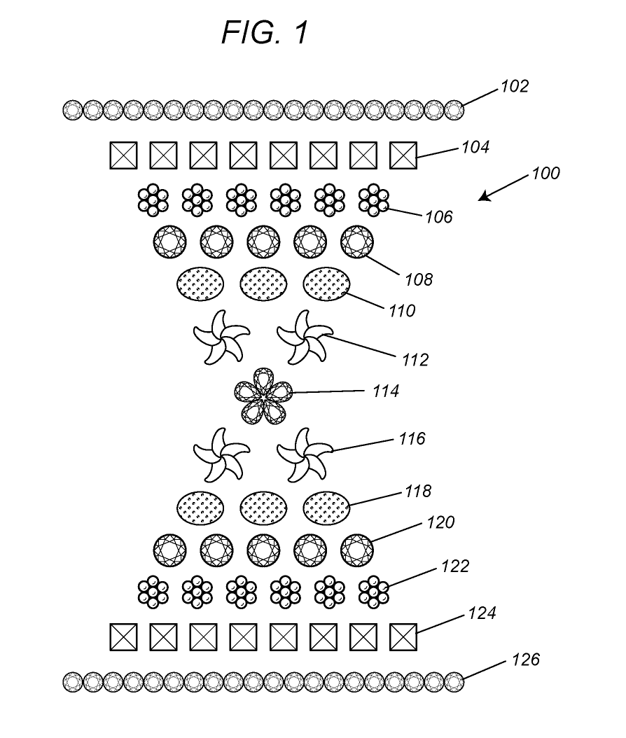

Turning to the drawings, FIG. 1 illustrates an introduction paragraph and conclusion paragraph board portion 100, comprising a plurality of discrete rows 102, 104, 106, 108, 110, 112, 114, 116, 118, 120, 122, 124 and 126 of visually and texturally different articles arranged in a selected order and in an hourglass shape. The hourglass can be complex or simple with varying numbers of rows of beads depending on the complexity of the writing product and the disclosure is not limiting in this aspect. The rows of beads may be different colors, shapes and textures, therefore allowing for users to apply kinesthetic learning techniques. Moreover, the articles can be derived from a variety of materials of sequences of repetitive shapes, colors, texture that have embossed aspects. This teaching aid provides users with visual disabilities the ability to learn academic writing structure though touch. Shapes are arranged in a dedicated sequence in order to allow these students the ability to kinesthetically feel its arrangement paralleling an academic paper. The teaching tool can be applied with users with or without a disability that learn through visualization as disclosed herein.

In some embodiments, the selected order of the rows of the top half of the hourglass of the introduction paragraph and conclusion paragraph board portion and the introduction paragraph comprises i) at least one general topic row 102 corresponding to at least one general topic sentence; ii) at least one specific topic row 104 corresponding to at least one specific topic sentence; iii) at least one first argument row 106 corresponding to at least one first argument topic sentence; iv) at least one second argument row 108 corresponding to at least one second argument topic sentence; v) at least one third argument row 110 corresponding to at least one third argument topic sentence; vi) at least one transition topic row 112 corresponding to at least one transition topic sentence; and vii) at least one thesis topic row 114 corresponding to at least one thesis topic sentence. In some embodiments, the selected order of the rows of the bottom half of the hourglass of the introduction paragraph and conclusion paragraph board portion and the conclusion paragraph comprises: i) at least one thesis topic row 114 corresponding to at least one thesis topic sentence; ii) at least one transition topic row 116 corresponding to at least one transition topic sentence; iii) at least one third argument row 118 corresponding to at least one third argument topic sentence; iv) at least one second argument row 120 corresponding to at least one second argument topic sentence; v) at least one first argument row 122 corresponding to at least one first argument topic sentence; vi) at least one specific topic row 124 corresponding to at least one specific topic sentence; and vii) at least one general topic row 126 corresponding to at least one general topic sentence.

In order to fully understand academic writing it is essential to understand the structure of a writing composition. In this aspect, the hourglass provides and tactile and visually symmetrical hourglass shape comprises of distinct rows of beads or articles and starts with a wide row at the top of the hourglass and narrowing in width with each successive row and then increasing in width to form the bottom portion of the hourglass. The user gains an understanding that a writing composition is structure in this way. The top half of the hourglass demonstrates how an introduction is formulated and the bottom half represents the structure of the conclusion of a paper or essay. The introduction is the foundation of an academic paper allowing for clarity and organization for all other paragraphs that follow. The first row 102 is a general sentence about the topic. The second row 104 a specific statement of the topic, followed by three arguments 106, 108 and 110. However, the disclosure herein is not intended to be limiting with respect to the number of rows. Then, the transition row 112 and thesis row 114 are presented. The different shapes and textures of the rows depicted correspond in each case with different structure composition elements, which is associated via the visually and tactile feel of the different rows. The bottom conclusion portion is a mirror image of the top introduction portion of the introduction paragraph and conclusion paragraph board portion 100, thereby allowing the user to comprehend a writing composition having the structure to come full circle from an introduction paragraph to a conclusion paragraph and make the necessary connections via the rows and their corresponding sentences. Tactile feeling of the shapes and textures of the rows of beads or articles combined with a corresponding writing composition allows users to write to kinesthetically feel the paper, visually see the shapes and understand how the writing composition is structured.

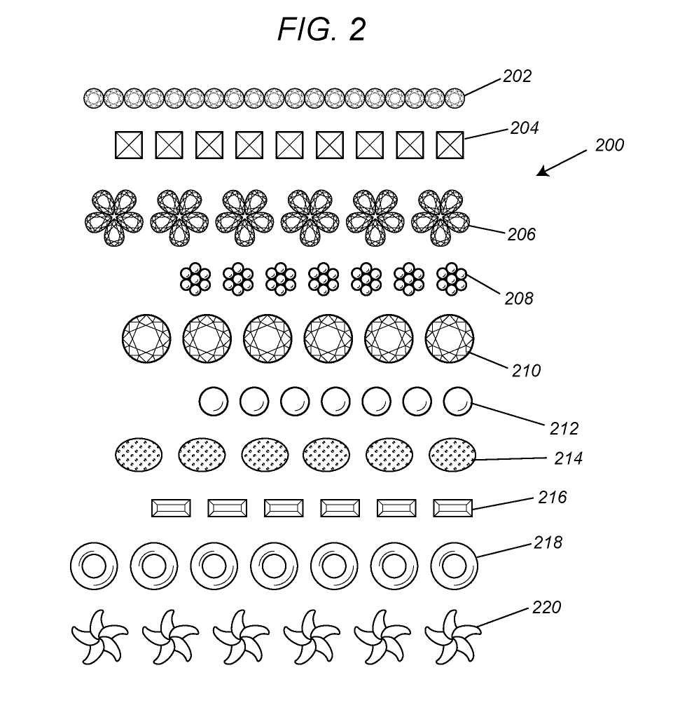

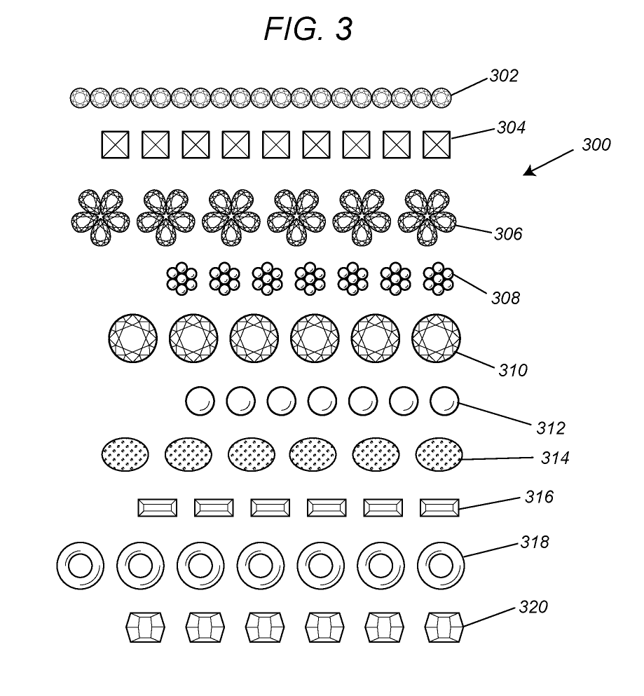

Turning again to the drawings, FIG. 2 is a depiction of a body paragraph board portion 200 comprising a plurality of discrete rows 202, 204, 206, 208, 210, 212, 214, 216, 218 and 220 of visually and texturally different articles arranged in a selected order and in an hourglass, square or rectangular shape. FIG. 3 is a depiction of a body paragraph board portion 300 comprising a plurality of discrete rows 302, 304, 306, 308, 310, 312, 314, 316, 318 and 320 of visually and texturally different articles arranged in a selected order and in an hourglass, square or rectangular shape.

The body paragraphs work similarly to the introduction and conclusion paragraphs. The body paragraph board portion 200 and a corresponding body paragraph start with a general topic sentence corresponding to a general topic row 202, a specific topic sentence specifying what exactly will be discussed and a corresponding to a specific topic row 204, a first sub-argument topic sentence and evidence and corresponding first sub-argument row 206, a first evidence sentence and a corresponding first evidence row 208, a second sub-argument topic sentence and evidence and corresponding second sub-argument row 210, a second evidence sentence and a corresponding second evidence row 212, a third sub-argument topic sentence and evidence and corresponding third sub-argument row 214, a third evidence sentence and a corresponding third evidence row 216, a summary argument topic sentence of what is to be discussed in this section and a corresponding summary argument topic row 218 and a transition argument topic sentence into the next body paragraph and a corresponding transition argument topic row 220. This selected order continues for all body paragraphs except the last body paragraph and a corresponding last body paragraph board 300, whereby there is a summary argument topic sentence and a corresponding summary argument topic sentence row 318 to the paragraph and a full summary argument topic sentence and a corresponding summarizing everything covered in the writing composition and a full summary argument topic row 320. This leads to the conclusion of the written or oral composition as previously discussed.

In some embodiments, the selected order of the rows of the body paragraph board portion and each body paragraph comprises i) at least one general topic row corresponding to at least one general topic sentence; ii) at least one specific topic row corresponding to at least one specific topic sentence; iii) at least one first sub-argument row corresponding to at least one first sub-argument topic sentence; iv) at least one second sub-argument row corresponding to at least one second sub-argument topic sentence; v) at least one third sub-argument row corresponding to at least one third sub-argument topic sentence; vi) at least one summary argument topic row corresponding to at least one summary argument topic sentence; and vii) at least one transition argument topic row corresponding to at least one transition argument topic sentence.

In some embodiments, the teaching aid for teaching written and oral composition further comprises at least one body paragraph board portion comprising a plurality of discrete rows of visually and texturally different articles arranged in a selected order and in an hourglass, square or rectangular shape, wherein the order of the rows corresponds to the selected order of the one or more sentences of a body paragraph of the written or oral composition, wherein the selected order of the rows of the body paragraph board portion and each body paragraph comprises i) at least one general topic row corresponding to at least one general topic sentence; ii) at least one specific topic row corresponding to at least one specific topic sentence; iii) at least one first sub-argument row corresponding to at least one first sub-argument topic sentence; iv) at least one first evidence row corresponding to at least one first evidence topic sentence; v) at least one second sub-argument row corresponding to at least one second sub-argument topic sentence; vi) at least one second evidence row corresponding to at least one second evidence topic sentence; vii) at least one third sub-argument row corresponding to at least one third sub-argument topic sentence; viii) at least one third evidence row corresponding to at least one third evidence topic sentence; ix) at least one summary argument topic row corresponding to at least one summary argument topic sentence; and x) at least one full summary argument topic row corresponding to at least one full summary argument topic sentence.

In some embodiments, the teaching aid for teaching written and oral composition further comprises at least one last body paragraph board portion comprising a plurality of discrete rows of visually and texturally different articles arranged in a selected order and in an hourglass, square or rectangular shape, wherein the order of the rows corresponds to the selected order of the one or more sentences of a last body paragraph of the written or oral composition, wherein the selected order of the rows of the last body paragraph board portion and each last body paragraph comprises i) at least one general topic row corresponding to at least one general topic sentence; ii) at least one specific topic row corresponding to at least one specific topic sentence; iii) at least one first sub-argument row corresponding to at least one first sub-argument topic sentence; iv) at least one second sub-argument row corresponding to at least one second sub-argument topic sentence; v) at least one third sub-argument row corresponding to at least one third sub-argument topic sentence; vi) at least one summary argument topic row corresponding to at least one summary argument topic sentence; and vii) at least one full summary argument topic row corresponding to at least one full summary argument topic sentence.

The visual teaching aid disclosed herein allows for textured sensations, thereby allowing students and those interested in improving their academic writing and oral composition skills with the ability to condense their writing and oral composition in a clear and concise way with the proper writing and oral composition structure. This is essential in academic writing given the difficulties many students with disabilities have in identifying the structure needed with an academic paper. Additionally, the teaching tool is easy to use for both the instructor and student given the shapes, colors, textures of the rows of bead or articles, and method disclosed herein. The teaching aid disclosed herein can be applied to other areas beside academic and can be complicated or simplified based on the needs and requirements of the person within the business or personal context. For visually impaired students and/or users with or without a visual disability it allows them the ability to feel the structure of an academic paper in ways previously not considered while providing them an opportunity to improve academically by providing a form of accommodation and accessibility to writing and oral composition.

The device, method and/or kit disclosed herein allows visually disabled students and users the ability to learn and acquire the necessary skills to constructively write academic papers, essays and oral compositions and at the same time enabling educators to reduce educational barriers in teaching composition writing. As an educational aid, the device, method and/or kit can be a value to students or users with and without disabilities. However, there is a focus on those with visual disabilities, in order to reach all users and students to understand the structure of an essay. This device and its use solve the communication barrier and teaching barriers encountered by sighted and non-sighted student and/or instructor that is a frequently an issue in the current teaching approaches and methods. The teaching aid can be applied with students and user with or without a visual disability and with students that learn through visualization. This device, method and/or kit specifically reduces or eliminates these barriers and allows writing composition education to be accessible and achievable for all students.

In some embodiments, the teaching aid for teaching written and oral composition further comprises that the teaching aid provides kinesthetic learning to the user. In some embodiments, teaching aid for teaching written and oral composition further comprises that the teaching aid provides kinesthetic learning to a visually impaired user. In some embodiments, teaching aid for teaching written and oral composition further comprises that the teaching aid provides kinesthetic learning to anyone who learns through a kinesthetic approach. By using rows of beads of varying shapes and textures to highlight the structure of a writing composition, users or students will be able to deconstruct the writing or oral composition and better understand its components via the kinesthetic approach disclosed herein.

In another aspect, disclosed herein is a method of using a teaching aid for teaching written and oral composition comprising the steps of: a) providing one or more introduction paragraphs, one or more body paragraphs and one or more conclusion paragraphs, wherein sentences of the paragraphs are arranged in a selected order; b) providing an introduction paragraph and conclusion paragraph board portion comprising a plurality of discrete rows of visually and texturally different articles arranged in a selected order and in an hourglass shape, wherein the order of the rows of a top half of the hourglass corresponds with the selected order of the one or more sentences of the introduction of the written or oral composition, and wherein the order of the rows of a bottom half of the hourglass corresponds to the selected order of the one or more sentences of the conclusion of the written or oral composition; c) correlating each row of the introduction paragraph and conclusion paragraph board via visual and/or tactile information provided by each distinct row with a corresponding sentence the one or more introduction paragraphs and the one or more conclusion paragraphs of the written or oral composition; d) providing at least one body paragraph board portion comprising a plurality of discrete rows of visually and texturally different articles arranged in a selected order and in an hourglass, square or rectangular shape, wherein the order of the rows corresponds with the selected order of the one or more sentences of body paragraph of the written or oral composition; and e) correlating each row of the body paragraph board via visual and/or tactile information provided by each distinct row with a corresponding sentence of the at least one body paragraph of the written or oral composition, wherein the sentences of the paragraphs are provided via an instructor reading, audio source, printed text source and/or Braille source, and wherein the teaching aid provides kinesthetic learning to the user.

In some embodiments, the method of using a teaching aid for teaching written and oral composition comprising the selected order of the rows of the top half of the hourglass of the introduction paragraph and conclusion paragraph board portion and each introduction paragraph comprises i) at least one general topic row corresponding to at least one general topic sentence; ii) at least one specific topic row corresponding to at least one specific topic sentence; iii) at least one first argument row corresponding to at least one first argument topic sentence; iv) at least one second argument row corresponding to at least one second argument topic sentence; v) at least one third argument row corresponding to at least one third argument topic sentence; vi) at least one transition topic row corresponding to at least one transition topic sentence; and vii) at least one thesis topic row corresponding to at least one thesis topic sentence.

In some embodiments, the method of using a teaching aid for teaching written or oral composition comprising the selected order of the rows of the bottom half of the hourglass of the introduction paragraph and conclusion paragraph board portion and each conclusion paragraph comprises i) at least one thesis topic row corresponding to at least one thesis topic sentence; ii) at least one transition topic row corresponding to at least one transition topic sentence; iii) at least one third argument row corresponding to at least one third argument topic sentence; iv) at least one second argument row corresponding to at least one second argument topic sentence; v) at least one first argument row corresponding to at least one first argument topic sentence; vi) at least one specific topic row corresponding to at least one specific topic sentence; and vii) at least one general topic row corresponding to at least one general topic sentence.

In some embodiments, the method of using a teaching aid for teaching written and oral composition comprising the selected order of the rows of the body paragraph board portion and each body paragraph comprises i) at least one general topic row corresponding to at least one general topic sentence; ii) at least one specific topic row corresponding to at least one specific topic sentence; iii) at least one first sub-argument row corresponding to at least one first sub-argument topic sentence; iv) at least one second sub-argument row corresponding to at least one second sub-argument topic sentence; v) at least one third sub-argument row corresponding to at least one third sub-argument topic sentence; vi) at least one summary argument topic row corresponding to at least one summary argument topic sentence; and vii) at least one transition argument topic row corresponding to at least one transition argument topic sentence.

In some embodiments, the method of using a teaching aid for teaching written and oral composition further comprises at least one body paragraph board portion comprising a plurality of discrete rows of visually and texturally different articles arranged in a selected order and in an hourglass, square or rectangular shape, wherein the order of the rows corresponds to the selected order of the one or more sentences of a body paragraph of the written or oral composition, wherein the selected order of the rows of the body paragraph board portion and each body paragraph comprises i) at least one general topic row corresponding to at least one general topic sentence; ii) at least one specific topic row corresponding to at least one specific topic sentence; iii) at least one first sub-argument row corresponding to at least one first sub-argument topic sentence; iv) at least one first evidence row corresponding to at least one first evidence topic sentence; v) at least one second sub-argument row corresponding to at least one second sub-argument topic sentence; vi) at least one second evidence row corresponding to at least one second evidence topic sentence; vii) at least one third sub-argument row corresponding to at least one third sub-argument topic sentence; viii) at least one third evidence row corresponding to at least one third evidence topic sentence; ix) at least one summary argument topic row corresponding to at least one summary argument topic sentence; and x) at least one full summary argument topic row corresponding to at least one full summary argument topic sentence.

In some embodiments, the method of using a teaching aid for teaching written and oral composition further comprises at least one last body paragraph board portion comprising a plurality of discrete rows of visually and texturally different articles arranged in a selected order and in an hourglass, square or rectangular shape, wherein the order of the rows corresponds to the selected order of the one or more sentences of a last body paragraph of the written or oral composition, wherein the selected order of the rows of the last body paragraph board portion and each last body paragraph comprises i) at least one general topic row corresponding to at least one general topic sentence; ii) at least one specific topic row corresponding to at least one specific topic sentence; iii) at least one first sub-argument row corresponding to at least one first sub-argument topic sentence; iv) at least one second sub-argument row corresponding to at least one second sub-argument topic sentence; v) at least one third sub-argument row corresponding to at least one third sub-argument topic sentence; vi) at least one summary argument topic row corresponding to at least one summary argument topic sentence; and vii) at least one full summary argument topic row corresponding to at least one full summary argument topic sentence.

In some embodiments, the method of using a teaching aid for teaching written and oral composition further comprises a step prior to step a) comprising a DEES (Define Explain Example Significance) step. DEES is the preliminary tool used to identify key features in summarizing and synthesizing materials read and researched in a concrete simplified way. It stands for define, explain, example and significance. The method allows students or users to define the key concepts/ideas/theorists/main ideas, explain in further details the benefits, risks, advantages disadvantages or provide additional information needed to further understand the key concepts/ideas/theorists/main ideas, identify examples of what is being discussed and provide its significance in the context of what is being discussed related back to the course context, the discussion, the theory, the situation, etc. This provides a synthesis in presentation and articulation of ideas that can aid in the composition of a paper or oral presentation as part of the brainstorming and outline stages.

In some embodiments, the method of using a teaching aid for teaching written and oral composition further comprises that the method provides kinesthetic learning to the user. In some embodiments, the method of using a teaching aid for teaching written and oral composition further comprises that the method provides kinesthetic learning to a visually impaired user or a disabled user. In some embodiments, the method of using a teaching aid for teaching written and oral composition further comprises that the method provides kinesthetic learning to any user.

In another aspect, disclosed herein is a kit for guiding a user through a writing process using a teaching aid for teaching written and oral composition, the kit comprising a) an introduction paragraph and conclusion paragraph board portion comprising a plurality of discrete rows of visually and texturally different articles arranged in a selected order and in an hourglass shape, wherein the order of the rows of a top half of the hourglass corresponds with the selected order of the one or more sentences of the introduction of the written or oral composition, and wherein the order of the rows of a bottom half of the hourglass corresponds to the selected order of the one or more sentences of the conclusion of the written or oral composition; b) at least one body paragraph board portion comprising a plurality of discrete rows of visually and texturally different articles arranged in a selected order and in an hourglass, square or rectangular shape, wherein the order of the rows corresponds with the selected order of the one or more sentences of body paragraph of the written or oral composition; and c) one or more introduction paragraphs, one or more body paragraphs and one or more conclusion paragraphs, wherein sentences of the paragraphs are arranged in a selected order, and wherein the sentences of the paragraphs are provided via an instructor reading, audio source, printed text source and/or Braille source, and wherein the teaching aid provides kinesthetic learning to the user.

Embodiments of the present disclosure are described herein. It is, however, expressly noted that the present disclosure is not limited by these embodiments, but rather the intention is that variations, modifications, and equivalents that are apparent to the person skilled in the art are also included. Additionally, the descriptions of various numbers of rows of beads with distinct colors, shapes and texture and corresponding criteria are given by way of example only, and the number of rows of beads with distinct colors, shapes and texture and corresponding criteria may vary to suit a particular application of writing or oral composition. In one example, the device, method and/or kit are effective for various types of writing and oral composition, including but not limited to descriptive, creative, expository, academic, persuasive, narrative, reports, presentations, etc. The teaching aid, method and/or kit are particularly useful for teaching users, the structural considerations of a written or oral composition. The oral presentation teaching method disclosed herein are applied to academic and non-academic contexts in order to concisely and collectively convey points expressed in a structured format allowing the user to focus on the key points rather than deter from their identified purpose.

The method of deconstructing a writing composition with the use of a system of rows of beads with distinct colors, shapes and/or texture of that assigns specific rows to the specific elements of a quality paper, essay or oral presentation. The teaching aid and its use with instructing users involves a complex method that needs to be integrated with the other approaches to teaching users about carefully structured composition methods.

The system of rows of beads with rows comprised of distinct colors, shapes and/or textures involves much more than assigning rows to certain sentences, it is a cognitive process in which students kinesthetic learn the essential components of a quality essay. Users will recognize what is present in good essays and what is deficient in lesser pieces of writing. Students will employ the system of rows of beads and learn the writing composition organizational process, as well as develop other checklists and mnemonics that will assist them in creating and editing their writing and oral composition skills. With the teaching aid and methods disclosed herein students are deconstructing the structure of paragraphs of a proper writing and oral composition and examining the functions of each sentence and how those sentences lend themselves to the overall organization of the paper, essay or oral composition. Standardized versions of the teaching aid can be supplied in a kit for use by teachers and students. The methods of using the teaching aid herein allows for students to identify and differentiate between writing compositions of varying quality.

Understanding the structural elements of a quality composition is an important aspect of writing that the users must learn and practice. This method can be used during the deconstruction of a writing composition, pre-writing process, editing stage of writing, etc. The teaching aid provides during the editing process the ability to ensure the user is fulfilling the structural requirements and standards for the written or oral composition. The teaching method disclosed herein can be simplified for younger users and made more complex for advanced users or professionals.

### EXAMPLE 1

The educator passes out a composition comprising an introduction paragraph, body paragraphs and one or more conclusion paragraphs, wherein sentences of the paragraphs are arranged in a selected order. The instructor distributes an introduction paragraph and conclusion paragraph board and body paragraph board(s). By studying the paragraph boards while reading, hearing, or using Braille to review the sentences of writing composition and their corresponding rows of distinct colors, shapes and/or texture the students kinesthetic learn the structure of the writing composition. The students are able to identify the key elements of an effective piece of writing, and at the same time are able to contrast the various rows of distinct colors, shapes and/or texture to see what structural elements are present or missing from the written composition. The paragraph boards may include additional rows of distinct colors, shapes and/or texture corresponding to additional sentences (i.e., arguments, evidence, conclusions, etc.). These may be referred to as context or recommendations as well. One visually impaired student used the board and was failing a required course. After being taught the structure of a paper using the teaching tool the student received 98% on a final report bringing her grade to a pass in the course. Upon further use of the teaching tool the student successfully increased all her grades in all her courses by a minimum of one letter grade. Additionally, another student with sight impairment used the teaching tool to help identify the organization of ideas in a way that could be easy for them to understand and present those ideas to others both orally and in written composition format. A visually impaired professional used the teaching tool to enhance their writing in a clinical setting allowing them to convey materials in a clearer format increasing the communication between themselves and their clients. Over a period of five years over 50 students used the teaching tool having various abilities and disabilities, including but not limited to physical disabilities, mental health disabilities and learning disabilities. The students who used the teaching tool significantly increased their comprehension and grades in their specified discipline with a minimum of 1 letter grade increase. 48 of the 50 students, including students with varying degrees of visual impairments and disabilities, acquired basic skills in writing composition needed to succeed. The 2 students who did not succeed refused to use the teaching tool reverting back to their old ways of learning; thus, were unsuccessful in their acquisition of written comprehension and composition.

### Definitions

For the purposes of this specification and appended claims, unless otherwise indicated, all numbers expressing quantities, percentages or proportions, and other numerical values used in the specification and claims, are to be understood as being modified in all instances by the term “about.” Accordingly, unless indicated to the contrary, the numerical parameters set forth in the following specification and attached claims are approximations that can vary depending upon the desired properties sought to be obtained. It is noted that, as used in this specification and the appended claims, the singular forms “a,” “an,” and “the,” include plural references unless expressly and unequivocally limited to one referent. As used herein, the term “include” and its grammatical variants are intended to be non-limiting, such that recitation of items in a list is not to the exclusion of other like items that can be substituted or added to the listed items. As used herein, the term “comprising” means including elements or steps that are identified following that term, but any such elements or steps are not exhaustive, and an embodiment can include other elements or steps.

The term “general topic sentence”, refers to a sentence that describes in general terms the topic or view being expressed.

The term “specific topic sentence”, refers to the specific aspects of the topic or view being expressed.

The term “sub-argument topic sentence”, refers to any minor arguments used to justify the main topics/points/arguments. These include and are not limited to the new points raised at the beginning of a new paragraph/point of articulation.

The term “evidence topic sentence”, refers to examples used from written texts, lived experiences or other information to substantiate or support the sub-arguments.

The term “summary argument topic sentence”, refers to summary of the paragraph or point being discussed as well as summary of the main points/arguments raised in the discussion/written composition.

The term “full summary argument topic sentence”, refers to a sentence that summarizes the main arguments of the entire composition.

The term “transition topic sentence”, refers to whenever you move from one idea to the next. By including transitions you force yourself to move on to new topics and do not dwell on one point. (i.e. If you use “to begin with,” “another example,” and “the most important reason” you have set yourself up to continue with three distinct arguments.) The transition sentence allows the user to ensure flow between points prior to moving to the next topic. Thus, the transition sentence sets the stage for the proceeding points to be discussed.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

While certain embodiments have been illustrated and described, it should be understood that changes and modifications can be made therein in accordance with ordinary skill in the art without departing from the technology in its broader aspects as defined in the following claims.

The present disclosure is not to be limited in terms of the particular embodiments described in this application. Many modifications and variations can be made without departing from its spirit and scope, as will be apparent to those skilled in the art. Functionally equivalent methods and devices within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or devices, which can of course vary. It is also to be understood that the terminology used herein is for the purpose of describing particular embodiments only, and is not intended to be limiting.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

What is claimed is:

1. A teaching aid for teaching written and oral composition, comprising:
a) an introduction paragraph, one or more body paragraphs and a conclusion paragraph, wherein sentences of the paragraphs are arranged in a selected order;
b) an introduction paragraph and conclusion paragraph board portion comprising a plurality of discrete rows of visually and texturally different articles arranged in a selected order and in an hourglass shape, wherein the order of the rows of a top half of the hourglass corresponds with the selected order of the one or more sentences of the introduction of the written or oral composition, and wherein the order of the rows of a bottom half of the hourglass corresponds to the selected order of the one or more sentences of the conclusion of the written or oral composition; and
c) at least one body paragraph board portion comprising a plurality of discrete rows of visually and texturally different articles arranged in a selected order and in an hourglass, square or rectangular shape, wherein the order of the rows corresponds with the selected order of the one or more sentences of body paragraph of the written or oral composition,
wherein the sentences of the paragraphs are provided via an instructor reading, audio source, printed text source and/or Braille source.

2. The teaching aid of claim 1, wherein the selected order of the rows of the top half of the hourglass of the introduction paragraph and conclusion paragraph board portion and the introduction paragraph comprises:
i. at least one general topic row corresponding to at least one general topic sentence;
ii. at least one specific topic row corresponding to at least one specific topic sentence;
iii. at least one first argument row corresponding to at least one first argument topic sentence;
iv. at least one second argument row corresponding to at least one second argument topic sentence;
v. at least one third argument row corresponding to at least one third argument topic sentence;
vi. at least one transition topic row corresponding to at least one transition topic sentence; and
vii. at least one thesis topic row corresponding to at least one thesis topic sentence.

3. The teaching aid of claim 1, wherein the selected order of the rows of the bottom half of the hourglass of the introduction paragraph and conclusion paragraph board portion and the conclusion paragraph comprises:
i. at least one thesis topic row corresponding to at least one thesis topic sentence;
ii. at least one transition topic row corresponding to at least one transition topic sentence;
iii. at least one third argument row corresponding to at least one third argument topic sentence;
iv. at least one second argument row corresponding to at least one second argument topic sentence;
v. at least one first argument row corresponding to at least one first argument topic sentence;
vi. at least one specific topic row corresponding to at least one specific topic sentence; and
vii. at least one general topic row corresponding to at least one general topic sentence.

4. The teaching aid of claim 1, wherein the selected order of the rows of the body paragraph board portion and each body paragraph comprises:
i. at least one general topic row corresponding to at least one general topic sentence;
ii. at least one specific topic row corresponding to at least one specific topic sentence;
iii. at least one first sub-argument row corresponding to at least one first sub-argument topic sentence;
iv. at least one second sub-argument row corresponding to at least one second sub-argument topic sentence;
v. at least one third sub-argument row corresponding to at least one third sub-argument topic sentence;
vi. at least one summary argument topic row corresponding to at least one summary argument topic sentence; and
vii. at least one transition argument topic row corresponding to at least one transition argument topic sentence.

5. The teaching aid of claim 1, further comprising at least one body paragraph board portion comprising a plurality of discrete rows of visually and texturally different articles arranged in a selected order and in an hourglass, square or rectangular shape, wherein the order of the rows corresponds to the selected order of the one or more sentences of a body paragraph of the written or oral composition, wherein the selected order of the rows of the body paragraph board portion and each body paragraph comprise:
i. at least one general topic row corresponding to at least one general topic sentence;
ii. at least one specific topic row corresponding to at least one specific topic sentence;
iii. at least one first sub-argument row corresponding to at least one first sub-argument topic sentence;
iv. at least one first evidence row corresponding to at least one first evidence topic sentence;
v. at least one second sub-argument row corresponding to at least one second sub-argument topic sentence;
vi. at least one second evidence row corresponding to at least one second evidence topic sentence;
vii. at least one third sub-argument row corresponding to at least one third sub-argument topic sentence;
viii. at least one third evidence row corresponding to at least one third evidence topic sentence;
ix. at least one summary argument topic row corresponding to at least one summary argument topic sentence; and
x. at least one full summary argument topic row corresponding to at least one full summary argument topic sentence.

6. The teaching aid of claim 1, further comprising at least one last body paragraph board portion comprising a plurality of discrete rows of visually and texturally different articles arranged in a selected order and in an hourglass, square or rectangular shape, wherein the order of the rows corresponds to the selected order of the one or more sentences of a last body paragraph of the written oral composition, wherein the selected order of the rows of the last body paragraph board portion and each last body paragraph comprise:
i. at least one general topic row corresponding to at least one general topic sentence;
ii. at least one specific topic row corresponding to at least one specific topic sentence;
iii. at least one first sub-argument row corresponding to at least one first sub-argument topic sentence;
iv. at least one second sub-argument row corresponding to at least one second sub-argument topic sentence;
v. at least one third sub-argument row corresponding to at least one third sub-argument topic sentence;
vi. at least one summary argument topic row corresponding to at least one summary argument topic sentence; and
vii. at least one full summary argument topic row corresponding to at least one full summary argument topic sentence.

7. The teaching aid of claim 1, further comprising that the teaching aid provides kinesthetic learning to the user.

8. The teaching aid of claim 1, further comprising that the teaching aid provides kinesthetic learning to a visually impaired user or a disabled user.

9. A method of using a teaching aid for teaching written and oral composition comprising the steps of:
a) providing an introduction paragraph, one or more body paragraphs and a conclusion paragraph, wherein sentences of the paragraphs are arranged in a selected order;
b) providing an introduction paragraph and conclusion paragraph board portion comprising a plurality of discrete rows of visually and texturally different articles arranged in a selected order and in an hourglass shape, wherein the order of the rows of a top half of the hourglass corresponds with the selected order of the one or more sentences of the introduction of the written or oral composition, and wherein the order of the rows of a bottom half of the hourglass corresponds to the selected order of the one or more sentences of the conclusion of the written or oral composition;
c) correlating each row of the introduction paragraph and conclusion paragraph board via visual and/or tactile information provided by each distinct row with a corresponding sentence the one or more introduction paragraphs and the one or more conclusion paragraphs of the written or oral composition;
d) providing at least one body paragraph board portion comprising a plurality of discrete rows of visually and texturally different articles arranged in a selected order and in an hourglass, square or rectangular shape, wherein the order of the rows corresponds with the selected order of the one or more sentences of body paragraph of the written or oral composition; and
e) correlating each row of the body paragraph board via visual and/or tactile information provided by each distinct row with a corresponding sentence of the at least one body paragraph of the written or oral composition, wherein the sentences of the paragraphs are provided via an instructor reading, audio source, printed text source and/or Braille source.

10. The method of claim 9, wherein the selected order of the rows of the top half of the hourglass of the introduction paragraph and conclusion paragraph board portion and the introduction paragraph comprises:
i. at least one general topic row corresponding to at least one general topic sentence;
ii. at least one specific topic row corresponding to at least one specific topic sentence;
iii. at least one first argument row corresponding to at least one first argument topic sentence;
iv. at least one second argument row corresponding to at least one second argument topic sentence;
v. at least one third argument row corresponding to at least one third argument topic sentence;
vi. at least one transition topic row corresponding to at least one transition topic sentence; and
vii. at least one thesis topic row corresponding to at least one thesis topic sentence.

11. The method of claim 9, wherein the selected order of the rows of the bottom half of the hourglass of the introduction paragraph and conclusion paragraph board portion and the conclusion paragraph comprises:
i. at least one thesis topic row corresponding to at least one thesis topic sentence;
ii. at least one transition topic row corresponding to at least one transition topic sentence;
iii. at least one third argument row corresponding to at least one third argument topic sentence;
iv. at least one second argument row corresponding to at least one second argument topic sentence;
v. at least one first argument row corresponding to at least one first argument topic sentence;
vi. at least one specific topic row corresponding to at least one specific topic sentence; and
vii. at least one general topic row corresponding to at least one general topic sentence.

12. The method of claim 9, wherein the selected order of the rows of the body paragraph board portion and each body paragraph comprises:
i. at least one general topic row corresponding to at least one general topic sentence;
ii. at least one specific topic row corresponding to at least one specific topic sentence;
iii. at least one first sub-argument row corresponding to at least one first sub-argument topic sentence;
iv. at least one second sub-argument row corresponding to at least one second sub-argument topic sentence;
v. at least one third sub-argument row corresponding to at least one third sub-argument topic sentence;
vi. at least one summary argument topic row corresponding to at least one summary argument topic sentence; and
vii. at least one transition argument topic row corresponding to at least one transition argument topic sentence.

13. The method of claim 9, further comprising at least one body paragraph board portion comprising a plurality of discrete rows of visually and texturally different articles arranged in a selected order and in an hourglass, square or rectangular shape, wherein the order of the rows corresponds to the selected order of the one or more sentences of a body paragraph of the written or oral composition, wherein the selected order of the rows of the body paragraph board portion and each body paragraph comprise:
i. at least one general topic row corresponding to at least one general topic sentence;
ii. at least one specific topic row corresponding to at least one specific topic sentence;
iii. at least one first sub-argument row corresponding to at least one first sub-argument topic sentence;
iv. at least one first evidence row corresponding to at least one first evidence topic sentence;
v. at least one second sub-argument row corresponding to at least one second sub-argument topic sentence;
vi. at least one second evidence row corresponding to at least one second evidence topic sentence;
vii. at least one third sub-argument row corresponding to at least one third sub-argument topic sentence;
viii. at least one third evidence row corresponding to at least one third evidence topic sentence;
ix. at least one summary argument topic row corresponding to at least one summary argument topic sentence; and
x. at least one full summary argument topic row corresponding to at least one full summary argument topic sentence.

14. The method of claim 9, further comprising at least one last body paragraph board portion comprising a plurality of discrete rows of visually and texturally different articles arranged in a selected order and in an hourglass, square or rectangular shape, wherein the order of the rows corresponds to the selected order of the one or more sentences of a last body paragraph of the written or oral composition, wherein the selected order of the rows of the last body paragraph board portion and each last body paragraph comprise:
i. at least one general topic row corresponding to at least one general topic sentence;
ii. at least one specific topic row corresponding to at least one specific topic sentence;
iii. at least one first sub-argument row corresponding to at least one first sub-argument topic sentence;
iv. at least one second sub-argument row corresponding to at least one second sub-argument topic sentence;
v. at least one third sub-argument row corresponding to at least one third sub-argument topic sentence;
vi. at least one summary argument topic row corresponding to at least one summary argument topic sentence; and
vii. at least one full summary argument topic row corresponding to at least one full summary argument topic sentence.

15. The method of claim 9, further comprising a step prior to step a) comprising a DEES (define explain example significance) step.

16. The method of claim 9, further comprising that the method provides kinesthetic learning to the user.

17. The method of claim 9, further comprising that the method provides kinesthetic learning to a visually impaired user or a disabled user.

18. A kit for guiding a user through a writing process using a teaching aid for teaching written and oral composition, the kit comprising:
a) an introduction paragraph and conclusion paragraph board portion comprising a plurality of discrete rows of visually and texturally different articles arranged in a selected order and in an hourglass shape, wherein the order of the rows of a top half of the hourglass corresponds with the selected order of the one or more sentences of the introduction of the written or oral composition, and wherein the order of the rows of a bottom half of the hourglass corresponds to the selected order of the one or more sentences of the conclusion of the written or oral composition;
b) at least one body paragraph board portion comprising a plurality of discrete rows of visually and texturally different articles arranged in a selected order and in an hourglass, square or rectangular shape, wherein the order of the rows corresponds with the selected order of the one or more sentences of body paragraph of the written or oral composition; and
c) an introduction paragraph, one or more body paragraphs and a conclusion paragraph, wherein sentences of the paragraphs are arranged in a selected order, and wherein the sentences of the paragraphs are provided via an instructor reading, audio source, printed text source and/or Braille source.
